(19) United States
(12) Patent Application Publication
(10) Pub. No.: US 2008/0317230 A1
(43) Pub. Date: Dec. 25, 2008

(54) Method and System to Use Feature Profiles Call-by-Call in Telecommunication Call Handling

(75) Inventors: Bizhan Karimi-Cherkandi, Boca Raton, FL (US); Farrokh Mohammadzadeh Kouchri, Boca Raton, FL (US)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 11/883,142

(22) PCT Filed: Jan. 27, 2006
(86) PCT No.: PCT/EP06/00698

§ 371 Date: Jul. 26, 2007

Related U.S. Application Data
(60) Provisional application No. 60/648,810, filed on Feb. 1, 2005.

(51) Int. Cl. H04M 3/42

(52) U.S. Cl. 379/201.02

(57) ABSTRACT

A method allowing a subscriber to use call handling features on a call by call basis defines a plurality of feature profiles, each including a number of call handling features. The method stores the feature profiles either in a customer premises equipment or in a related switch, and activates one of the feature profiles by selecting one of the feature profiles and applying the call handling features in the feature profile to the calls as long as the feature profile is activated.

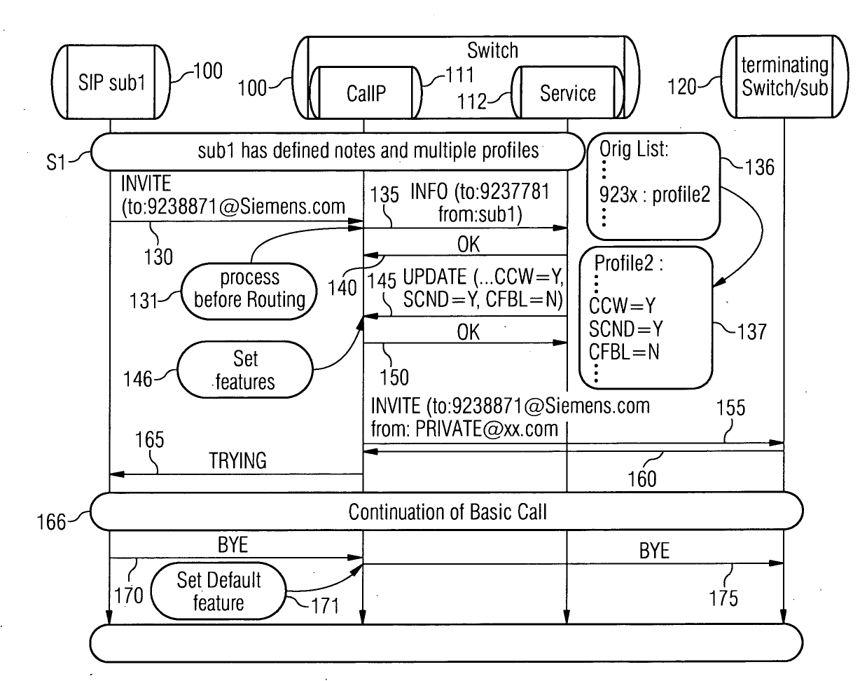

This application claims priority to pending U.S. Provisional Patent Application Ser. No. 60/648,810 (Attorney Docket No. 2005P01755US), filed 1 Feb. 2005 the entire contents of which are incorporated herein in its entirety.

The present invention relates to a method and to a system allowing a subscriber to use call handling features on a call-by-call basis.

Many features for handling a call in a telecommunication network can be activated/deactivated by a subscriber when originating a call which shall affect the call to be originated, such as call handling features like Cancel Call Waiting (CCW), Suppress Calling Name Delivery (SCND), Select Carrier (dial CAC). Everytime when the subscriber intends to use a call handling feature, the subscriber has to activate/deactivate the features manually for each call if not set as default and in many cases, the combination of multiple feature activation may be very complicated if possible at all.

For example, if a subscriber wishes to originate a call with Cancel Call Waiting CCW and Suppress Calling Name Delivery SCND, he may not be able to dial two access codes prior to call establishment. A good example for a single feature activation is when the subscriber activated CCW (cancel call waiting) and then establishes a call. In such case, the established call shall not be disturbed by an incoming call, i.e. call waiting shall not invoked during this one call even though the subscriber has subscription for it. Traditionally to activate CCW, the subscriber needs to go off-hook and dials an access code that corresponds to CCW and when the ccw is granted, subscriber hears dial tone again. Therefore, he dials now and establishes a call that he did not want to be disturbed by an incoming call. There are a set of access codes that invoke different features like CCW. Such features work this way: off-hook, dial tone, dial access code, and hear corresponding announcement. Knowing this, it is easy to understand that subscriber does not have always the possibility of combining (activating) two or more features at the same time, not to mention that users need to memorize all these access codes.

On the terminating side, the subscriber may activate/deactivate one or more features for incoming calls apart from a black-list and a white-list which are call number selective. As a significant drawback, the subscriber may not activate/deactivate these features on a call by call or a call specific basis. Call forwarding is here a good example of a terminating feature. The subscriber has call forwarding subscription, but he likes to activate this feature only for certain incoming calls. However, the subscriber may define a “black list” in the sense that certain calls from callers whose number match with a number in the list, should be either denied or forwarded. Same way, subscriber may define a “white list” that contains directory numbers (calling name number) which will receive a privileged handling, for example call denial (or forwarding) can be applied to all incoming calls except the ones in the white list.

Therefore, one finds currently the situation that the subscriber has to activate/deactivate some features for origination prior to placing a call when considering the outgoing call side. Considering the incoming call side, features are activated/deactivated permanently. A combination of different features either on the outgoing call side or on the incoming call side is very complicated if possible at all.

It is therefore the aim of the present invention to provide a method enabling the subscriber to originate various call handling features which might be in addition directory number and/or time selective.

These objective are achieved according to the present invention by a method allowing a subscriber to use call handling features on a call by call basis, and moreover may automate them said method comprising the steps of:

a) defining a plurality of feature profiles, each comprising a number of call handling feature (CCW, SCND, CFBL) setup;

b) storing the feature profiles either in a customer premises equipment (CPE) or in a related switch;

c) activating one of the feature profiles by selecting one of the feature profiles and applying the call handling feature setup (e.g. CCW, SCND, CFBL) in the feature profile to the calls as long as the feature profile is activated.

These method steps according to the present invention offers the opportunity to the subscriber to apply a selectable number of call handling features assigned to one feature profile to his outgoing and/or incoming calls. By defining a plurality of profiles the subscriber is enabled to select a distinct combination of preferred features by selecting the respective profile. Of course, this profile can be defined in a way that it is only active for the next originating call and deactivate itself after the call is terminated.

In order to be more flexible with respect to the handling of incoming and outgoing calls, the step of defining at least one feature profile for incoming calls and at least one feature profile for outgoing calls may be comprised.

Alternatively, the step of defining within at least one of the plurality of feature profile a first feature list for incoming calls and a second feature list for outgoing calls may be comprised in order to define incoming call and outgoing call handling and to apply the respective features on the incoming calls and the other respective features on the outgoing calls.

A preferred way to determine a match of an incoming call with a rule or an entry associated with the features listed in the feature list may comprise the step of basing the feature list for incoming calls on a calling party number which is filtered based on rules in a rules list that are defined to generate an event, i.e. the assignment of a distinct feature profile in dependency of the calling party number. In an analogue way, this could be done for outgoing calls by basing the feature list for outgoing calls on a called party number which is filtered based on rules in a rules list that are defined to generate an event, i.e. the assignment of a distinct feature profile in dependency of the called party number. Therefore, a match in the rules list with respect to the calling party number or the called party number and/or a time-table causes an event whereby features profiles are activated or deactivated according to specifically defined events.

Of course the subscriber may also have the possibility to select one of his profiles manually (e.g. simply by one access code). The list for incoming calls defines calling party numbers, and has a corresponding rule in the rules list. The rule maybe time of day so that an incoming call from a certain directory number at a specific time of day results in a match. When this match occurs, an event is then generated which leads to the activation of the feature profile assigned to this match. This profile then contains certain features to be activated. It maybe call forwarding, or call denial. It can also mean that a previously activated feature (like call forwarding) is deactivated for this incoming call. The entries in the mentioned list can be wild carded, i.e. the DN may be written as 923**** in which case it corresponds to any incoming call from callers whose directory number begins with 923. The opportunity to define wild cards allows to select groups of calling party numbers and/or called party numbers. Therefore, the general procedure provides that a match in a list comprising the calling party number or the called party number and/or a time-table causes an event whereby features profiles are activated or deactivated according to specifically defined events. comment: defined events maybe time based; i.e. at 4 pm a profile gets activated. Or the event maybe the occurrence of a call related property: for example if the incoming call has a specific attribute like emergency (in newer system and technology), then profile xx shall be activated. In such a case the profile xx may contain the activation of “call forwarding do not answer” (CFDA). It means whenever the user receives a call, he wishes to forward to another phone number if no one answers the call in a given interval of time.

In another preferred embodiment of the present invention the method further comprises the step of defining at least one time table comprising a number of time periods; said time table assigning a feature profile to each time period to be applied during the respective time period. This feature allows to structure the activation/deactivation of feature profiles along the day/week/month and/or daily, monthly, weekly, etc. For example, this feature allows to adapt the incoming call handling to the office hour of a company and/or a specific employee in a company.

Another preferred embodiment of the present invention may comprise the step of defining a default feature profile that, in addition, may even reside after activation and deactivation of other feature profiles, or when no match or no selection of a profile occurs.

To support the subscriber in most convenient way to define his user-specific features profiles the step of defining the feature profiles in a web-based manner may be foreseen. A web-based application usually offers the interface and the routines to generate the feature profiles for example by selecting the features from a drop-down list or by clicking the respective fields in a feature mask.

Examples of the present invention will become apparent more in detail with the following description of the drawings which illustrates the steps of the present invention for a number of preferred embodiments. Thereby, the drawing shows schematically a sub-structure of a telecommunication network (not shown). This sub-structure 2 comprises a traditional SIP subscriber 100 subscribed for Call-by-Call feature, a switch 110 and a terminating switch 120 (or next switch in the call chain) to which various other subscribers are coupled. The traffic is effected according to session initiated protocol (SIP) standard which is commonly used in internet protocol (IP) networks. The network could alternatively operate on a Time Division Multiplex (TDM) standard as well. The subscriber 100 comprises a customer premises equipment (CPE) which is not illustrated in detail. The switch 110 comprises a call processing unit 111 and a call-by-call service unit 112. For call handling, in a step S1 the subscriber 100 has defined a plurality of originating lists 136 (only one originating list 136 is shown for the sake of clarity) and feature profiles 137 (only one feature 137 is shown for the sake of clarity) which are currently controlled in the service unit 112 of the switch 110. The bar representing step S1 indicates the normal call processing with an involvement of the subscriber side 100, the call processing unit 111 and the service unit 112 in this step S1.

To control these originating lists 136 and feature profiles 137, the selection of controlling them in the switch 110 is preferred because many events are generated in the switch 110, for example terminating line busy status is triggered in the switch 110 (this is an event in the switch). Or if a second incoming call is being deflected, it is an event that maybe happening inside the switch. Or when the status of an announcement (or voice mail) is changed, this is an event inside the switch 110. For an intelligent costumer premises equipment (CPE), many events that were handled in switch 110 can be handled in the CPE, for example automatic call forwarding (CPE is customer premises equipment and it could be a phone itself or a residential gateway or an access device that the phone may be connected to).

The application of the originating lists 136 and the feature profiles 137 is now illustrated by an outgoing call to number 9238871@siemens.com which starts with an SIP:INVITE message 130. This status is now the status before routing the call at 131. The call processing unit 111 forwards the relevant information contained in INVITE message 130 by an INFO message 135 to the service unit 112 where this INFO message 135 is checked against the call originating list 136. One entry in this list shows a rule for called party numbers starting with the sequence “923”. The other digits of the called party number are wild-carded. The INFO message 135 causes a match related to this entry in the call originating rule list 136 which causes the selection of the feature profile 137. This feature profile 137 comprises the following features: Cancel Call Waiting CCW is ON, Suppress Calling Name Delivery SCND is On and Call Forwarding Busy Line CFBL is OFF and more. The service unit 112 responds with an OK message 140 (optionally) and a signaling UPDATE message 145 to the call processing unit 111 along with all configured features found in profile 137. At 146 it is indicated that the afore-mentioned features are now set. The call processing unit 111 acknowledges the signaling UPDATE message 145 with an OK message 150 (optionally). The present INVITE message 130 is now “enriched” with the features of the feature profile 137 and is routed now as INVITE message 155 through the switch 110 to the terminating switch 120 which i.e. is dealing the incoming calls of directory number 9238871@siemens.com. In response to this INVITE message 155 TRYING messages 160 and 165 are routed uplink to the subscriber 100 originating the call and the call is now processed with the features according to feature profile 137. For the normal call processing the involvement of the subscriber 100, the switch 6 and the terminating switch 120 is illustrated by a bar 166 representing this step. With BYE message 170 and 175 the call is terminated from the signaling side. In the switch 110 the BYE message 170, 175 causes an event that resets the activation of the feature profile 137 and activates the default features which could be selected by activating another feature profile containing the or these default feature(s) which is indicated by at 171.

In this preferred embodiment, the hardware and the software for this feature selecting method is incorporated in the service unit 112 and 111 of the switch 110. Since both is possible (additionally or alternatively in the CPE at the subscriber 100), it is preferred to realize it in the switch 110 since many events are switch-internal and therefore can be used to invoke feature profiles 137.

The originating call list 136 and feature profiles 137 are defined by subscriber 100 (e.g. by a web page) or by the craft assisting subscriber 100. Obviously, the subscriber 100 is aware of these feature profiles so that he can use them meaningfully. The lists 136 and feature profiles 137 may reside again in the CPE or in the switch 110. The profiles can activate/deactivate features for origination, and termination (CCW, SCND and CFBL were an example for origination (outgoing call handling features), and call forwarding for the entries in a white list is an example for terminating (incoming call handling features).

Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

1. A method allowing a subscriber to use call handling features on a call by call basis, comprising the steps of:
a) defining a plurality of feature profiles, each comprising a number of call handling features;
b) storing the feature profiles either in a customer premises equipment or in a related switch;
c) activating one of the feature profiles by selecting one of the feature profiles and applying the call handling features in the feature profile to the calls as long as the feature profile is activated.

2. The method of claim 1, further comprising the step of defining at least one feature profile for incoming calls and at least one feature profile for outgoing calls.

3. The method of claim 1, further comprising the step of defining within at least one of the plurality of feature profile a first feature list for incoming calls and a second feature list for outgoing calls.

4. The method according to claim 3, further comprising the step of basing the feature list for incoming calls on a calling party number which is filtered based on rules in a rules list that are defined to generate an event, wherein a distinct feature profile is assigned in dependency of the calling party number.

5. The method according to claim 3, further comprising the step of basing the feature list for outgoing calls on a called party number which is filtered based on rules in a rules list that are defined to generate an event, wherein a distinct feature profile is assigned in dependency of the called party number.

6. The method according to claim 4, wherein wild cards are used to select at least one of groups of calling party numbers and called party numbers.

7. (canceled)

8. The method of claim 1, further comprising the step of defining at least one time table comprising a number of time periods; said time table assigning a feature profile to each time period to be applied during the respective time period.

9. The method of claim 1, further comprising the step of defining a default feature profile.

10. The method of claim 1, further comprising the step of defining the feature profiles in a web-based manner.

11. A system allowing a subscriber to use call handling features on a call by call basis, comprising:
a) means for defining a plurality of feature profiles, each comprising a number of call handling features;
b) means for storing the feature profiles either in a customer premises equipment or in a related switch;
c) means for activating one of the feature profiles by selecting one of the feature profiles and applying the call handling features in the feature profile to the calls as long as the feature profile is activated.

12. The method according to claim 5, wherein wild cards are used to select at least one of groups of calling party numbers and called party numbers.

13. The method according to claim 4, wherein a match in the rules list with respect to one of the calling party number and the called party number and a time-table causes an event whereby feature profiles are changed according to specifically defined events.

14. The method according to claim 4, wherein a match in the rules list with respect to one of a time-table and one of the calling party number and the called party number causes an event whereby feature profiles are changed according to specifically defined events.
